(19) United States
(12) Patent Application Publication
(10) Pub. No.: US 2024/0327091 A1
(43) Pub. Date: Oct. 3, 2024

(54) CONTAINER, METHOD FOR MANUFACTURING CONTAINER, DEVICE FOR MANUFACTURING CONTAINER, SEAL BAR, AND FILM ASSEMBLY

(71) Applicant: IDEMITSU UNITECH CO.,LTD., Tokyo (JP)

(72) Inventor: Ryo KATADA, Tokyo (JP)

(73) Assignee: IDEMITSU UNITECH CO.,LTD., Tokyo (JP)

(21) Appl. No.: 18/580,307

(22) PCT Filed: Jul. 14, 2022
(86) PCT No.: PCT/JP2022/027770

§ 371 Date: Jan. 18, 2024

(30) Foreign Application Priority Data
Jul. 20, 2021 (JP) 2021-119506

(51) Int. Cl. B65D 75/58; B31B 70/16; B31B 70/62; B31B 70/64; B31B 70/81; B31B 160/10; B65D 33/25; B65D 75/30

(52) U.S. Cl. CPC B65D 75/5827; B31B 70/16; B31B 70/81; B65D 33/2583; B65D 75/30; B31B 70/62; B31B 70/64; B31B 2160/10

(57) ABSTRACT

Provided is a container including a part in which a first film that configures a container body, a tearing strip, a belt-shaped base, and a second film that configures the container body are stacked in this order. A bonding region in which the first film, the tearing strip, the belt-shaped base, and the second film are bonded to each other is formed traversing the tearing strip and the belt-shaped base. A tab is defined by a cut in a non-bonded region adjacent to the bonding region. The cut passes through at least the first film and the tearing strip. An edge, of the bonding region, on a side of the tab is at least partially not orthogonal to a longitudinal direction of the tearing strip.

### TECHNICAL FIELD

The present invention relates to a container, a container manufacturing method, a container manufacturing device, a seal bar, and a film assembly.

### BACKGROUND ART

A bag-shaped container is used for packaging medicines, foods, or the like. A technique of forming an opening in a container body using members that are called a tearing strip and a cut tape has been known. For instance, Patent Literature 1 describes a container including: a film that includes a first area and a second area opposed to each other; an elongated tearing strip to be bonded to the first area; an elongated belt-shaped base disposed between the tearing strip and the second area; a tab defined by a cut that passes through the first area of the film and the tearing strip, and a surrounding seal area bonding the first area and the second area in an area surrounding the tab.

### CITATION LIST

### Patent Literature(s)

Patent Literature 1: JP 2019-51963 A

### SUMMARY OF THE INVENTION

### Problem(s) to be Solved by the Invention

In a container described in Patent Literature 1, it is possible to form an opening in a container body by breaking a belt-shaped base in a surrounding seal portion when a tearing strip is grasped and pulled at a tab, and thereafter separating the tearing strip from the belt-shaped base and pulling the tearing strip. However, it is necessary to pull the tearing strip with a relatively large force at a moment of breaking the belt-shaped base. There is thus still room for improvement in terms of smoothness in separating the tearing strip and the belt-shaped base from each other.

It is therefore an object of the invention to provide a container, a container manufacturing method, a container manufacturing device, a seal bar, and a film assembly that make it easier to form an opening in a container in which an opening is to be formed in a container body using a tearing strip, by making it smoother to separate the tearing strip and a belt-shaped base from each other with use of a bonding region.

### Means for Solving the Problem(s)

[1] A container including: a first film that configures a container body; a tearing strip; a belt-shaped base; and a second film that configures the container body, in which the container includes a part in which the first film, the tearing strip, the belt-shaped base, and the second film are stacked in this order, a bonding region in which the first film, the tearing strip, the belt-shaped base, and the second film are bonded to each other is formed traversing the tearing strip and the belt-shaped base, a tab is defined by a cut in a non-bonded region, the cut passing through at least the first film and the tearing strip, the non-bonded region being adjacent to the bonding region, and an edge, of the bonding region, on a side of the tab is at least partially not orthogonal to a longitudinal direction of the tearing strip.
[2] The container according to [1], the edge, of the bonding region, on the side of the tab includes at least one protrusion.
[3] The container according to [2], in which the protrusion has a chevron shape, a trapezoidal shape, a rectangular shape, or an arc shape.
[4] The container according to [2] or [3], in which the protrusion has a width of greater than or equal to 0.3 mm.
[5] The container according to [4], in which the protrusion has a width of less than or equal to 3 mm.
[6] The container according to any one of [2] to [5], in which the protrusion has a protrusion height of greater than or equal to 0.3 mm.
[7] The container according to [6], in which the protrusion has a protrusion height of less than or equal to 5 mm.
[8] The container according to any one of [2] to [7], in which the protrusion includes a plurality of protrusions, and the edge, of the bonding region, on the side of the tab is provided with the plurality of the protrusions that overlap with the tearing strip.
[9] The container according to [8], in which a width of a range over which the plurality of protrusions are provided is greater than or equal to a width of the tearing strip.
[10] The container according to any one of [1] to [9], further including: a first base provided continuously with the belt-shaped base; a second base opposed to the first base and bonded to the first film; and a first engagement portion and a second engagement portion that respectively protrude from the first base and the second base and are engageable with each other.
[11] The container according to any one of [1] to [10], in which the first film and the second film are provided by folding back a single film.
[12] The container according to any one of [1] to [11], in which the bonding region at least partially surrounds the tab.
[13] The container according to any one of [1] to [12], in which the container body has a bag shape.
[14] A container manufacturing method including: forming a bonding region by stacking a first film that configures a container body, a tearing strip, a belt-shaped base, and a second film that configures the container body in this order and bonding the first film, the tearing strip, the belt-shaped base, and the second film to each other, the bonding region formed traversing the tearing strip and the belt-shaped base; and forming a tab defined by a cut in a non-bonded region, the cut passing through at least the first film and the tearing strip, the non-bonded region being adjacent to the bonding region, in which an edge, of the bonding region, on a side of the tab is at least partially not orthogonal to a longitudinal direction of the tearing strip.
[15] A container manufacturing device including: a unit configured to form a bonding region by stacking a first film that configures a container body, a tearing strip, a belt-shaped base, and a second film that configures the container body in this order and bonding the first film, the tearing strip, the belt-shaped base, and the second film to each other, the bonding region formed traversing the tearing strip and the belt-shaped base; and a unit configured to form a tab defined by a cut in a non-bonded region, the cut passing through at least the first film and the tearing strip, the non-bonded region being adjacent to the bonding region, in which an edge, of the bonding region, on a side of the tab is at least partially not orthogonal to a longitudinal direction of the tearing strip.
[16] A seal bar including: a planar shape surrounding at least three sides of a predetermined region; and at least one protrusion on an inner edge of at least one side of the planar shape.
[17] A container including: a first film that configures a container body; a tearing strip; a belt-shaped base; and a second film that configures the container body, in which the container includes a part in which the first film, the tearing strip, the belt-shaped base, and the second film are stacked in this order, the container further includes a protector that is bonded, on a side of the belt-shaped base, to a region covering a tab defined by a cut passing through the first film, the tearing strip, and the belt-shaped base, a bonding region in which the first film, the tearing strip, the belt-shaped base, and the protector are bonded to each other is formed traversing the tearing strip and the belt-shaped base, the tab is provided in a non-bonded region adjacent to the bonding region, and an edge, of the bonding region, on a side of the tab is at least partially not orthogonal to a longitudinal direction of the tearing strip.
[18] The container according to [17], in which the container body has a bag shape, the edge, of the bonding region, on the side of the tab includes at least one protrusion, the protrusion has a width in a range from 0.3 mm to 3 mm, and the protrusion has a protrusion height in a range from 0.3 mm to 5 mm.
[19] The container according to or [18], further including: a first base provided continuously with the belt-shaped base; a second base opposed to the first base and bonded to the first film; and a first engagement portion and a second engagement portion that respectively protrude from the first base and the second base and are engageable with each other.
[20] A film assembly including: a film; and at least two elongated members that are attached to one surface of the film and are separated from each other along one direction of the film, in which the elongated members each include a tearing strip, a belt-shaped base, and a protector, the belt-shaped base being stacked on the tearing strip, the protector being bonded, on a side of the belt-shaped base, to a region covering a tab defined by a cut passing through the film, the tearing strip, and the belt-shaped base, a bonding region in which the film, the tearing strip, the belt-shaped base, and the protector are bonded to each other is formed traversing the tearing strip and the belt-shaped base, the tab is provided in a non-bonded region adjacent to the bonding region, and an edge, of the bonding region, on a side of the tab is at least partially not orthogonal to a longitudinal direction of the tearing strip.
[21] The film assembly according to [20], in which the edge, of the bonding region, on the side of the tab includes at least one protrusion, the protrusion has a width in a range from 0.3 mm to 3 mm, and the protrusion has a protrusion height in a range from 0.3 mm to 5 mm.
[22] The film assembly according to or [21], further including: a first base provided continuously with the belt-shaped base; a second base opposed to the first base and bonded to the film; and a first engagement portion and a second engagement portion that respectively protrude from the first base and the second base and are engageable with each other.

According to the above-described configurations, at a part where the edge, of the bonding region, on the side of the tab is not orthogonal to the longitudinal direction of the tearing strip, force acts in a concentrated manner on the part prior to the other part when the tearing strip is pulled. This makes it possible to break the belt-shaped base with less force, and makes it smoother to separate the tearing strip and the belt-shaped base from each other with use of the bonding region.

### BRIEF DESCRIPTION OF DRAWINGS

FIG. 1 is a plan view of a bag-shaped container according to a first exemplary embodiment of the invention.

FIG. 2 is a cross-sectional view taken along a line II-II of FIG. 1.

FIG. 3 is a cross-sectional view taken along a line III-III of FIG. 1.

FIG. 4A illustrates a principle relating to the breaking of a belt-shaped base in an intersection with a bonding region.

FIG. 4B illustrates the principle relating to the breaking of the belt-shaped base in the intersection with the bonding region.

FIG. 5 is an enlarged view of a surrounding seal portion of the bag-shaped container illustrated in FIG. 1.

FIG. 6 illustrates a process of manufacturing the bag-shaped container according to the first exemplary embodiment of the invention.

FIG. 7 is an enlarged cross-sectional view of a portion of the manufacturing process illustrated in FIG. 6.

FIG. 8 is a plan view of a bag-shaped container according to a second exemplary embodiment of the invention.

FIG. 9 is an enlarged view of a surrounding seal portion of the bag-shaped container illustrated in FIG. 8.

FIG. 10 is a plan view of a bag-shaped container according to a third exemplary embodiment of the invention.

FIG. 11 is a cross-sectional view taken along a line XI-XI of the bag-shaped container illustrated in FIG. 10.

FIG. 12 is a cross-sectional view of a bag-shaped container according to a fourth exemplary embodiment of the invention.

FIG. 13 is a plan view of a bag-shaped container according to a fifth exemplary embodiment of the invention.

FIG. 14 is a cross-sectional view taken along a line XIV-XIV of the bag-shaped container illustrated in FIG. 13.

FIG. 15 illustrates an exemplary configuration of a film assembly according to the fifth exemplary embodiment of the invention.

FIG. 16 illustrates a process of manufacturing a bag-shaped container using the film assembly illustrated in FIG. 15.

### DESCRIPTION OF EMBODIMENT(S)

The following describes preferred exemplary embodiments of the invention in detail with reference to the accompanying drawings. It is to be noted that, in this description and the accompanying drawings, components that have substantially the same functional configuration are indicated by the same reference signs, and thus redundant description thereof is omitted.

### First Exemplary Embodiment

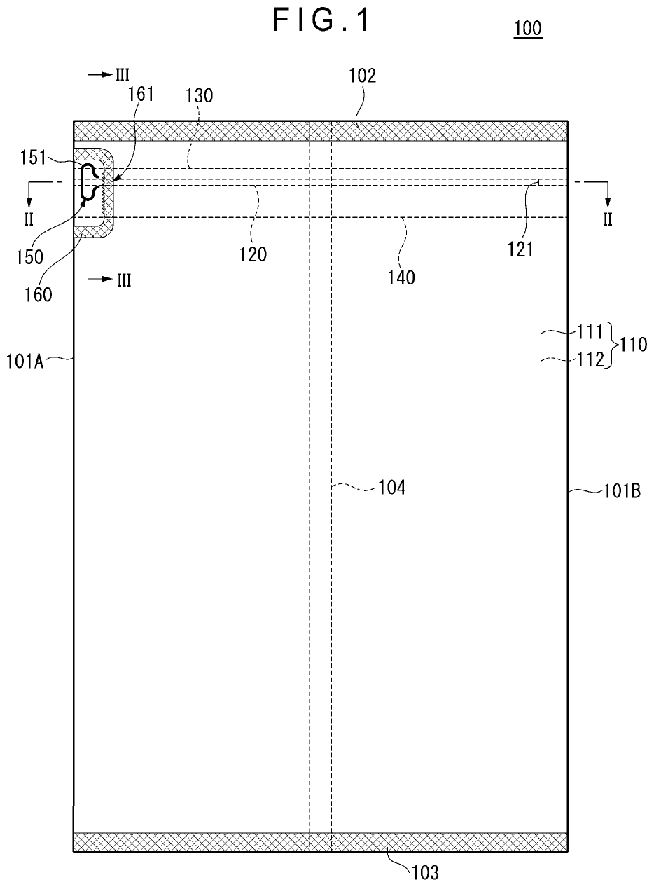

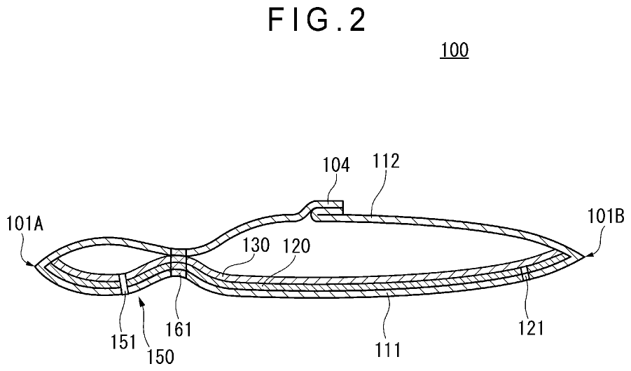

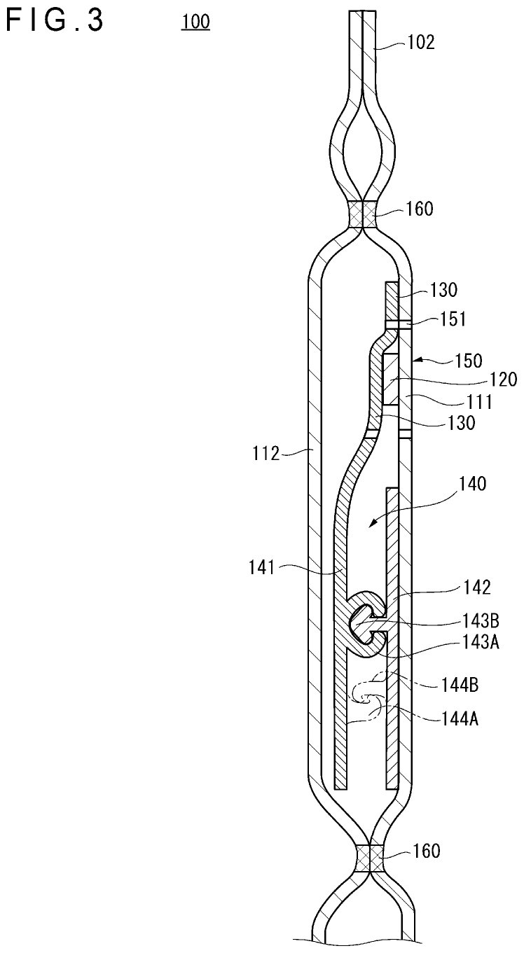

FIG. 1 is a plan view of a bag-shaped container according to a first exemplary embodiment of the invention. FIG. 2 is a cross-sectional view taken along a line II-II of FIG. 1. FIG. 3 is a cross-sectional view taken along a line III-III of FIG. 1. As illustrated in the figures, a bag-shaped container 100 includes a film 110, a tearing strip 120, a belt-shaped base 130, and a zipper portion 140. The film 110 is folded back on side portions 101A and 101B of the bag-shaped container 100. Opposed parts of a top seal portion 102 are bonded to each other, opposed parts of a bottom seal portion 103 are bonded to each other, and opposed parts of a back seal portion 104 are bonded to each other. The film 110 is thereby formed into a bag-shaped container body. It is to be noted that a method of forming the container body with use of the film 110 is not particularly limited. For instance, the film 110 may be folded back on only one of the side portions, i.e., the side portion 101A (or the side portion 101B), of the bag-shaped container 100, and a side seal portion may be provided on the other side portion. Alternatively, the container body may be formed using two films by providing respective side seal portions on the side portions 101A and 101B. Further, for instance, the bag-shaped container may be provided in a state where the top seal portion 102 or the bottom seal portion 103 is not formed for a purpose of enclosing contents, and a top seal portion or a bottom seal portion may be formed afterward. Although the example is described in the present exemplary embodiment in which the bag-shaped container body is provided with use of the film 110, in another exemplary embodiment, a container may be provided that includes a container body other than a bag-shaped container body.

The tearing strip 120 and the belt-shaped base 130 are elongated members that extend in the same direction as each other, and are interposed between two surfaces of the film 110 that are included in the container body. In the following description, the two surfaces are also referred to as a first film 111 and a second film 112. As described above, folding back a single film provides the first film 111 and the second film 112 in the illustrated example; however, the first film 111 and the second film 112 may be provided as multiple separate films in another example. As illustrated in the cross-sectional views of FIGS. 2 and 3, the first film 111, the tearing strip 120, the belt-shaped base 130, and the second film 112 are stacked in this order in a part where the tearing strip 120 and the belt-shaped base 130 are interposed. It is to be noted that those members may be stacked with other members interposed therebetween. Further, the stacked members are not necessarily bonded to each other except in a surrounding seal portion 160 to be described later. Specifically, the tearing strip 120 is bonded to the first film 111 and the belt-shaped base 130 is bonded to the tearing strip 120 and the first film 111, but the belt-shaped base 130 and the second film 112 are not bonded to each other except in the surrounding seal portion 160.

The film 110 includes, for instance, a single-layered or multi-layered thermoplastic resin film. A thermoplastic resin includes, for instance, low density polyethylene (LDPE), linear low density polyethylene (LLDPE), or polypropylene (PP). Examples of PP include a polypropylene homopolymer (HPP), a polypropylene random copolymer (RPP), and a polypropylene block copolymer (BPP). In a case where the film 110 includes a multi-layered film, biaxially oriented polypropylene (OPP), biaxially oriented polyethylene terephthalate (OPET), or biaxially oriented nylon (ONy) may be used for a surface base. A resin included in the film 110 is not necessarily derived from a fossil fuel, and may be, for instance, an environmentally friendly bio-plastic or a mixture of the resin derived from the fossil fuel and the bio-plastic. Preferably usable as the bio-plastic are, for instance, bio-polyethylene and bio-polypropylene. Further, bio-based PET and bio-nylon, for instance, are also available as the bio-plastic. The film 110 may include a layer of a metal material such as aluminum, or a layer of an inorganic material.

The tearing strip 120 and the belt-shaped base 130 are each formed by extrusion molding of a resin composition containing, for instance, a polyolefin-based resin. The polyolefin-based resin is exemplified by LDPE, LLDPE, or PP. Examples of PP include HPP, RPP, and BPP. A resin included in each of the tearing strip 120 and the belt-shaped base 130 is not necessarily derived from a fossil fuel, and may be, for instance, an environmentally friendly bio-plastic or a mixture of the resin derived from the fossil fuel and the bio-plastic. Preferably usable as the bio-plastic are, for instance, bio-polyethylene and bio-polypropylene. To the material of at least one of the tearing strip 120 or the belt-shaped base 130, a known additive such as a stabilizer, an antioxidant, a lubricant, an antistatic agent, or a colorant may be added as necessary.

Here, as will be described later, when an opening is to be formed in the container body of the bag-shaped container 100, specifically, in the first film 111, the tearing strip 120 undergoes interfacial peeling from the belt-shaped base 130. Accordingly, in the present exemplary embodiment, the tearing strip 120 and the belt-shaped base 130 include a combination of resins having low compatibility with each other. Specifically, the tearing strip 120 may include a polypropylene-based resin, and the belt-shaped base 130 may include a low-density polyethylene-based resin. The combination of resins having low compatibility with each other including resins other than the polyolefin-based resin is exemplified by the following, in the form of the first resin/the second resin: LDPE/RPP, LLDPE/RPP, LDPE/HPP, LLDPE/HPP, LDPE/polystyrene (PS), LLDPE/PS, RPP/PS, HPP/PS, LDPE/polyethylene terephthalate (PET), LLDPE/PET, RPP/PET, HPP/PET, PS/PET, LDPE/nylon (Ny), LLDPE/Ny, RPP/Ny, HPP/Ny, and PS/Ny. It is to be noted that LLDPE may at least partially be metallocene-based linear low-density polyethylene. As described above, the tearing strip 120 and the belt-shaped base 130 may include the bio-plastic, or the mixture of the resin derived from the fossil fuel and the bio-plastic. Preferably usable as the bio-plastic are bio-polyethylene and bio-polypropylene. Further, available as the bio-plastic are, for instance, bio-based PET, bio-polystyrene, and bio-nylon.

As illustrated in FIG. 3, the zipper portion 140 includes a first base 141 provided continuously with the belt-shaped base 130, a second base 142 opposed to the first base 141 and bonded to the first film 111, and engagement portions 143A and 143B that respectively protrude from the first base 141 and the second base 142 and are engageable with each other. Materials of the zipper portion 140 are, for instance, similar to those of the belt-shaped base 130 described above. It is to be noted that the shapes of the engagement portions 143A and 143B are not limited to the illustrated male and female shapes, and it is possible to employ various shapes of engagement portions of known zippers having a combination of, for instance, a claw shape, a hook shape, and a knob shape. In the illustrated example, the engagement portion 143A has a female shape and the engagement portion 143B has a female shape; however, they may be the other way around. Further, the engagement portions may not be one pair. For instance, one or more pairs of additional engagement portions may be provided, such as hooks 144A and 144B illustrated in an imaginary line. A resin included in the zipper portion 140 is not necessarily derived from a fossil fuel, and may be, for instance, an environmentally friendly bio-plastic or a mixture of the resin derived from the fossil fuel and the bio-plastic. Preferably usable as the bio-plastic are, for instance, bio-polyethylene and bio-polypropylene. To the material of the zipper portion 140, a known additive such as a stabilizer, an antioxidant, a lubricant, an antistatic agent, or a colorant may be added as necessary.

In the bag-shaped container 100 according to the present exemplary embodiment, a user grasps and pulls the tearing strip 120 from a tab 150 provided at a position close to one of the side portions, i.e., the side portion 101A, of the bag-shaped container 100. This makes it possible for the tearing strip 120 to tear the first film 111 and form an opening portion in the container body. A cut 121 that passes through the first film 111 and the tearing strip 120 may be provided at a position close to the side portion 101B, of the bag-shaped container 100, on an opposite side to the tab 150. Providing the cut 121 makes it easier to form an end of the tearing; however, the end of the tearing is formed without the cut 121 when the film 110 is easily tearable, for instance, and the cut 121 is thus not necessarily provided. After the opening portion is formed by the tearing with use of the tearing strip 120, an inside of the container body is accessible through a space between the first base 141 and the second base 142 of the zipper portion 140. However, engaging the engagement portions 143A and 143B with each other makes it possible to reseal the container body, and disengaging the engagement makes it possible to re-unseal the container body.

The tab 150 and the surrounding seal portion 160 are provided for an operation of forming the opening in the container body with use of the tearing strip 120, as described above. Specifically, the tab 150 is defined by a cut 151 that passes through the first film 111, the tearing strip 120, and the belt-shaped base 130 at a position close to one of the side portions, i.e., the side portion 101A, of the bag-shaped container 100. Upon forming the opening portion in the container body with use of the tearing strip 120, it is possible for the user to easily grasp and pull the tearing strip 120 by raising the tab 150 toward a side of the first film 111. In the illustrated example, the cut 151 has a planar shape of a pot. An open portion corresponding to a mouth of the pot shape faces toward which the opening is formed with use of the tearing strip 120. It is to be noted that the cut 151 is not particularly limited in planar shape, and the planar shape of the cut 151 in another embodiment may be, for instance, a C shape, a U shape, or a horseshoe shape.

The surrounding seal portion 160, which is a bonding region that surrounds the tab 150, includes an intersection 161 that traverses the tearing strip 120 and the belt-shaped base 130. The first film 111, the tearing strip 120, the belt-shaped base 130, and the second film 112 are bonded to each other in the surrounding seal portion 160 by, for instance, heat sealing or ultrasonic sealing. The tab 150 is provided in a non-bonded region adjacent to the surrounding seal portion 160, that is, in a region where the belt-shaped base 130 and the second film 112 are not bonded to each other. It is to be noted that the surrounding seal portion 160 only has to surround the tab 150 at least partially, and does not necessarily have to enclose an entire circumference of the tab 150. In the illustrated example, the surrounding seal portion 160 has a U-shaped planar shape with both end portions in contact with the side portion 101A of the bag-shaped container 100 where the film 110 is folded back, thus surrounding three sides of the tab 150 except for the side portion 101A. In another example, the surrounding seal portion 160 may surround the tab 150 with the top seal portion 102 or the side seal portion. When the top seal portion is provided afterward, the entire circumference of the tab 150 may not be surrounded at the time when the bag-shaped container is provided.

Surrounding the tab 150 with the above-described surrounding seal portion 160 spatially separates a space between the first film 111 and the second film 112 in the non-bonded region including the tab 150 from another space inside the container body across the surrounding seal portion 160 serving as the bonding region. This therefore makes it possible to maintain sealing performance of the container body even when the tab 150 is defined by the cut 151 that passes through the first film 111.

It is to be noted that the cut 151 that defines the tab 150 only has to pass through at least the first film 111 and the tearing strip 120, and may not have to pass through the belt-shaped base 130, for instance, due to processing errors. Even when the user grasps only the first film 111 and the tearing strip 120 at the tab 150, the interfacial peeling between the tearing strip 120 and the belt-shaped base 130 occurs, and unsealing is thus possible. Further, the cut 151 may partially pass through the second film 112, for instance, due to processing errors, as long as the passing through is to an extent that the user does not grasp the second film 112 together with the tearing strip 120 at the tab 150. As described above, the surrounding seal portion 160 separates the space in which the tab 150 is provided from the other space inside the container body. Thus, the sealing performance of the container body is not affected even the cut 151 partially passes through the second film 112.

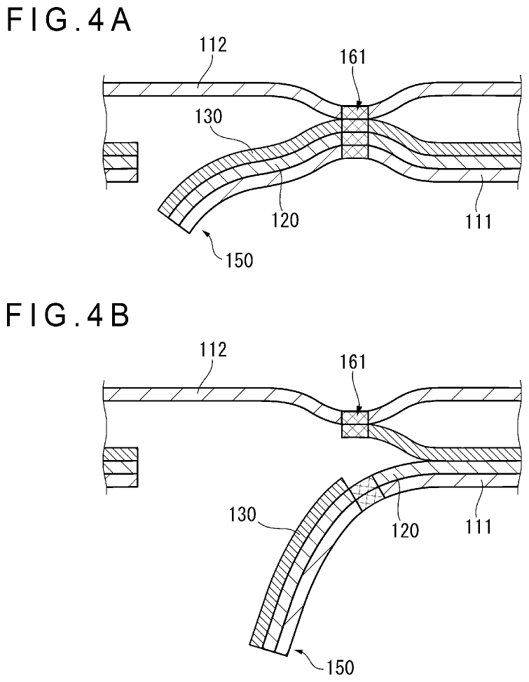

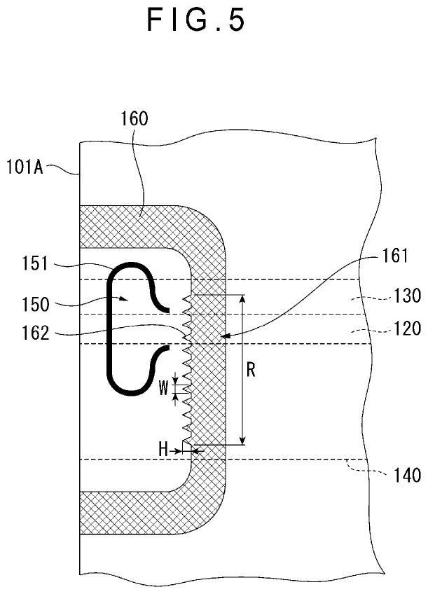

Further, as will be described below with reference to FIGS. 4 and 5, in the present exemplary embodiment, the intersection 161 of the surrounding seal portion 160 forms the bonding region that traverses the tearing strip 120 and the belt-shaped base 130, and an edge, of the bonding region, on a side of the tab 150 in the intersection 161 has a shape that is at least partially not orthogonal to a longitudinal direction of the tearing strip 120. This makes it possible to smoothly separate the tearing strip 120 and the belt-shaped base 130 from each other when forming the opening portion in the container body with use of the tearing strip 120.

As illustrated in FIG. 4A, in a state where pulling of the tearing strip 120 from the tab 150 has not yet reached the intersection 161, the belt-shaped base 130 is pulled along with the tearing strip 120 and the first film 111 while being torn at a part on an extension of the cut 151 in the longitudinal direction. At this point of time, resistance to the pulling of the tearing strip 120 is relatively high due to tearing of the belt-shaped base 130. However, the belt-shaped base 130 is broken in the intersection 161 as illustrated in FIG. 4B, which makes it possible to pull the tearing strip 120 separated from the belt-shaped base 130 with relatively low resistance to tear the first film 111, and to form the opening in the container body.

Here, as described above, the first film 111, the tearing strip 120, the belt-shaped base 130, and the second film 112 are bonded to each other in the intersection 161. Accordingly, when the pulling of the tearing strip 120 reaches the intersection 161 as illustrated in FIG. 4B, force acts for separating the first film 111, the tearing strip 120, and the belt-shaped base 130 that are being pulled from the second film 112 that is not being pulled. In the intersection 161, the second film 112 and the belt-shaped base 130 are bonded to each other at a normal bonding strength, whereas the tearing strip 120 and the belt-shaped base 130 include the combination of resins having low compatibility with each other as described above and are thus bonded to each other at a relatively low bonding strength. Therefore, in the intersection 161, the belt-shaped base 130 and the second film 112 are not separated from each other by the above-described force, and instead, the interfacial peeling occurs between the tearing strip 120 and the belt-shaped base 130. As a result, breaking occurs in the intersection 161 between a portion of the belt-shaped base 130 that has been pulled together with the tearing strip 120 so far, and the other portion of the belt-shaped base 130 bonded to a side of the second film 112.

FIG. 5 is an enlarged view of the surrounding seal portion of the bag-shaped container illustrated in FIG. 1. As illustrated in the figure, in the intersection 161 of the surrounding seal portion 160 that intersects the tearing strip 120, at least one protrusion 162 is provided on the edge, of the bonding region, on the side of the tab 150. The protrusion 162 is a part in which the edge of the bonding region protrudes toward the tab 150. It is to be noted that the protrusion 162 may protrude from the edge of the bonding region in a case where the protrusion 162 is not provided as in the illustrated example, or the protrusion 162 may protrude from a bottom of a concave portion that is provided in the edge of the bonding region. In the latter case, the protrusion 162 may not necessarily protrude relative to the edge of the bonding region of the case where the protrusion 162 is not provided. Further, although multiple protrusions 162 in the illustrated example have a successive saw blade shape, the protrusions 162 may be discretely provided. It is only necessary that at least one protrusion 162 be provided in such a manner as to overlap with the tearing strip 120, and it is more preferable that multiple protrusions 162 be provided in such a manner as to overlap with the tearing strip 120.

Providing the above-described protrusion 162 makes it easier to break the belt-shaped base 130 in the intersection 161 when the tearing strip 120 is pulled to form the opening in the container body. More specifically, when the tearing strip 120 is pulled from the side of the tab 150, the force acts for separating the first film 111, the tearing strip 120, and the belt-shaped base 130 that are being pulled from the second film 112 that is not being pulled in the intersection 161, in a concentrated manner on a tip end of the protrusion 162 prior to the other part. Concentrating the force on the tip end of the protrusion 162 makes it possible to: break the belt-shaped base 130 with small force as compared with a case where, for instance, the edge of the bonding region has a straight line that is orthogonal to the longitudinal direction of the tearing strip 120 and force is thus distributed; and separate the tearing strip 120 and the belt-shaped base 130 from each other as illustrated in FIG. 4B.

According to the above-described configuration, a maximum value of an unsealing strength of the bag-shaped container of the present exemplary embodiment is reduced as compared with a case where the opening is formed in the bag-shaped container provided with no protrusion in the bonding region. The unsealing strength corresponds to force necessary for forming the opening in the container body by pulling the tearing strip. Where the unsealing strength in the case where the opening is formed in the bag-shaped container provided with no protrusion in the bonding region is set to 100%, the unsealing strength of the bag-shaped container according to the present exemplary embodiment is preferably less than or equal to 95%, more preferably less than or equal to 90%, still more preferably less than or equal to 80%, and particularly preferably less than or equal to 70%.

In order to effectively concentrate the force, a width W of the protrusion 162, i.e., a dimension in a width direction of the tearing strip 120 of the individual protrusion 162, is preferably less than or equal to 100%, more preferably less than or equal to 80%, still more preferably less than or equal to 60%, and particularly preferably less than or equal to 45% of a width of the tearing strip 120. When a width of a common tearing strip 120 is assumed based on a size of a finger of the user grasping the tearing strip 120, the width W of the protrusion 162 is preferably less than or equal to 3 mm, more preferably less than or equal to 2 mm, and still more preferably less than or equal to 1.3 mm. In order to stably form the protrusion 162 by heat sealing or ultrasonic sealing, the width W of the protrusion 162 is preferably greater than or equal to 0.3 mm, more preferably greater than or equal to 0.5 mm, and still more preferably greater than or equal to 0.7 mm. When the above-described range is applied to the width of the common tearing strip 120, the width W is preferably greater than or equal to 5%, more preferably greater than or equal to 10%, and still more preferably greater than or equal to 25% of the width of the tearing strip 120. Further, in order to stably form the protrusion 162, a protrusion height H of the protrusion 162, i.e., a height of the individual protrusion 162 in a planar shape protruding from concave portions on both sides thereof or from a linear part, is preferably greater than or equal to 0.3 mm, more preferably greater than or equal to 0.5 mm, and still more preferably greater than or equal to 0.7 mm. In order not to unnecessarily increase a size of the surrounding seal portion 160, the protrusion height H of the protrusion 162 is preferably less than or equal to 5 mm, more preferably less than or equal to 2 mm, and still more preferably less than or equal to 1.5 mm. Further, when multiple protrusions 162 are provided on the edge, of the bonding region, on the side of the tab 150 in the surrounding seal portion 160 as in the illustrated example, a width R of a range over which the multiple protrusions 162 are provided is preferably greater than or equal to the width of the tearing strip 120.

It is to be noted that as long as it is possible to provide a part on which the force acts in a concentrated manner prior to the other part as described above, similar effects are obtainable, and a chevron-shaped protrusion as illustrated in the figure may thus be not provided. In another example, a protrusion having a trapezoidal shape, a rectangular shape, an arc shape, or the like may be provided. Further, a part having any other shape than the protrusion result in similar effects, because as long as the edge, of the bonding region that overlaps with the tearing strip 120, on the side of the tab 150 is at least partially not orthogonal to the longitudinal direction of the tearing strip 120, the part where the force acts in a concentrated manner prior to the other part upon pulling the tearing strip 120 is present. Specifically, the edge, of the bonding region that overlaps with the tearing strip 120, on the side of the tab 150 may have a shape that includes at least one concave portion or an oblique corner formed obliquely with respect to the longitudinal direction of the tab 150.

Further, the effects of the intersection 161 and the protrusion 162 as described above are exhibited independently of the fact that the surrounding seal portion 160 surrounds the tab 150. Accordingly, in another exemplary embodiment of the invention, the bonding region that is formed traversing the tearing strip and the belt-shaped base may not necessarily be the surrounding seal portion that surrounds the tab.

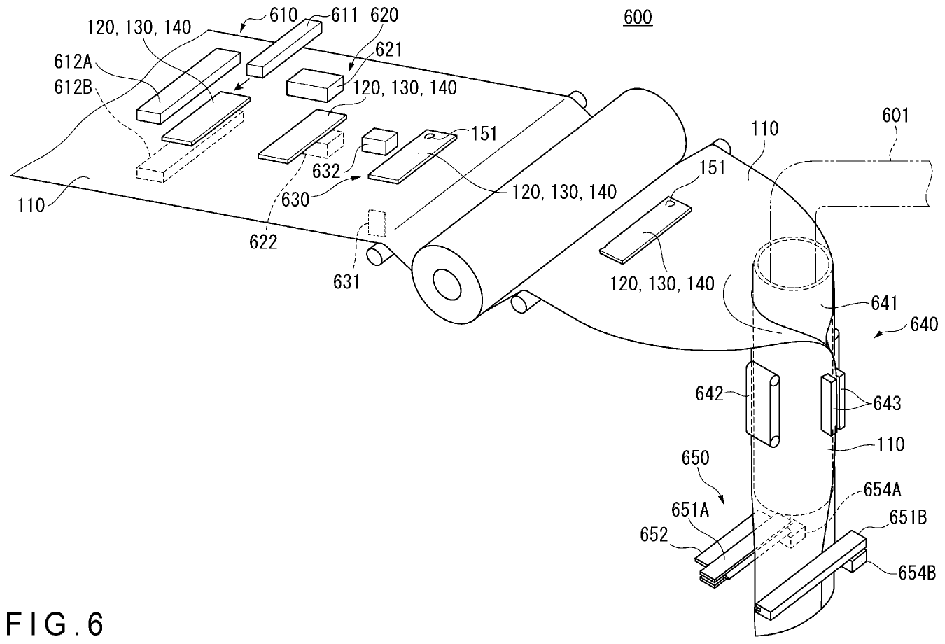

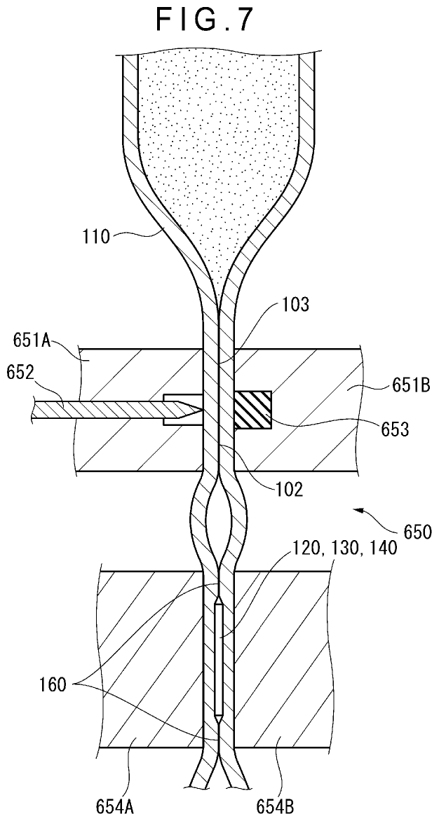

Referring to FIGS. 6 and 7, a method of manufacturing the bag-shaped container according to the present exemplary embodiment will be described. FIG. 6 illustrates a process of manufacturing the bag-shaped container according to the first exemplary embodiment of the invention. FIG. 7 is an enlarged cross-sectional view of a portion of the manufacturing process illustrated in FIG. 6.

As illustrated in FIG. 6, a manufacturing device 600 includes an elongated-member bonding unit 610, a tab forming unit 620, a cut forming unit 630, a back-seal forming unit 640, and a top/bottom-seal forming unit 650. It is to be noted that the cut forming unit 630 is omitted when the above-described cut 121 is not provided in the bag-shaped container. In the manufacturing device 600, the film 110 drawn out from, for instance, an unillustrated roll is processed in the above-described units while being intermittently conveyed. In the following, further description is given of those units.

The elongated-member bonding unit 610 bonds an elongated member including the tearing strip 120, the belt-shaped base 130, and the zipper portion 140 along a width direction of the film 110 conveyed in a longitudinal direction. The tearing strip 120, the belt-shaped base 130, and the zipper portion 140 may be molded as an integrated elongated member by extrusion (including co-extrusion), for instance. In another example, the tearing strip 120 may be molded separately from the belt-shaped base 130 and the zipper portion 140, and the tearing strip 120, and the belt-shaped base 130 and the zipper portion 140 may be bonded to the film 110 by respective bonding methods different from each other. Here, the elongated member is bonded to a part that is to be the first film 111 after a process of folding back to be described later.

Specifically, the elongated-member bonding unit 610 includes a feeder 611 and seal bars 612A and 612B. The feeder 611 sends the elongated member having a predetermined length and disposes the elongated member at a predetermined position on the film 110. The feeder 611 may include an unillustrated cutter that cuts the elongated member to have the predetermined length. The seal bars 612A and 612B sandwich therebetween the film 110 together with the elongated member disposed thereon, and bond the elongated member to the film 110 by, for instance, heat sealing or ultrasonic sealing. Alternatively, an adhesive may be applied in advance between the elongated member and the film 110, and the seal bars 612A and 612B may sandwich and press the film 110 and the elongated member that are stacked on each other to thereby bond the film 110 and the elongated member to each other.

The tab forming unit 620 forms a tab defined by the cut 151 that passes through the film 110 and the elongated member bonded to the film 110. Specifically, the tab forming unit 620 includes a cutter 621 and a receiver base 622. The cutter 621 has a planar shape corresponding to the cut 151. As described above, the elongated member is bonded to the part to be the first film 111, but the film 110 has not yet been folded back at this stage. The cut 151 that passes through the film 110 and the elongated member thus will not pass through the second film 112 of the completed bag-shaped container 100.

The cut forming unit 630 forms the cut 121 in the film 110 and the elongated member bonded to the film 110. Specifically, the cut forming unit 630 includes a cutter 631 and a receiver base 632. In the present exemplary embodiment, the cut 121 passes through the film 110 and the tearing strip 120 and does not pass through the belt-shaped base 130. A cut depth of the cutter 631 is thus adjusted to a value corresponding to a total thickness of the film 110 and the tearing strip 120. Although not illustrated, a region including the cut 121 may be pressed after the cut 121 is formed to thereby improve the sealing performance of the container body in the vicinity of the cut 121.

The back seal forming unit 640 rolls the film 110 into a tube in such a manner that the both sides in the width direction of the film 110 meet each other, and forms the back seal portion 104. The back seal forming unit 640 thus forms a general shape of the container body including the first film 111 and the second film 112. Specifically, the back seal forming unit 640 includes a roll core 641, a conveyor belt 642, and a sealer 643. The film 110 is conveyed downward by the conveyor belt 642 while being rolled around the roll core 641. The film 110 rolled into the tube is folded back on both sides in the width direction corresponding to the side portions 101A and 101B of the bag-shaped container 100. The first film 111 and the second film 112 as described above are thereby formed. The sealer 643 bonds both end portions in the width direction of the rolled film 110 to each other by, for instance, heat sealing or ultrasonic sealing, to thereby form the back seal portion 104.

The top/bottom seal forming unit 650 forms the top seal portion 102 and the bottom seal portion 103 in the film 110 that has been on folded back on the both sides in the width direction, and cuts the film 110 in the width direction to thereby form the film 110 into the bag-shaped container 100. In addition, the top/bottom seal forming unit 650 forms the above-described surrounding seal portion 160. As illustrated in the enlarged cross-sectional view of FIG. 7, the top/bottom seal forming unit 650 includes seal bars 651A and 651B, a cutter 652, a receiver base 653, and sealers 654A and 654B. The sealers 654A and 654B form the surrounding seal portion 160.

The seal bars 651A and 651B each have an upper part and a lower part with the cutter 652 interposed therebetween. The respective upper parts of the seal bars 651A and 651B are opposed to each other, and the respective lower parts of the seal bars 651A and 651B are opposed to each other. The opposed portion of the upper parts and the opposed portion of the lower parts become the top seal portion 102 and the bottom seal portion 103 by, for instance, heat sealing or ultrasonic sealing. The cutter 652 and the receiver base 653 move together with the seal bars 651A and 651B to thereby move toward and away from each other, and cut the film 110 in the width direction between the top seal portion 102 and the bottom seal portion 103 that are formed by the seal bars 651A and 651B.

Here, in the illustrated example, the roll core 641 of the back seal forming unit 640 is hollow, and a filling device 601 is inserted from above into an inside of the roll core 641. The filling device 601 discharges contents in synchronization with the seal bars 651A and 651B sandwiching the film 110 in the top/bottom seal forming unit 650. As a result, a space provided above the bottom seal portion 103 of the bag-shaped container 100 is filled with the contents. Thereafter, when the seal bars 651A and 651B have moved away from each other, the contents are conveyed downward together with the film 110 beyond the seal bars 651A and 651B, following which the top seal portion 102 is formed to thereby seal the bag-shaped container 100.

The sealers 654A and 654B sandwich the film 110 in synchronization with the seal bars 651A and 651B and form the surrounding seal portion 160 by, for instance heat sealing or ultrasonic sealing. Seal bars of the sealers 654A and 654B each have a planar shape corresponding to the surrounding seal portion 160 as illustrated in FIG. 5, for instance. Specifically, the seal bar has a U-shaped planar shape surrounding three sides of a predetermined region in which the tab is defined by the cut 151, and the inner edge of at least one side of the planar shape includes at least one protrusion. Alternatively, the seal bar may have a shape that is not the U shape if a part off the film 110 is included, for instance, a substantially rectangular planar shape enclosing four sides of the above-described predetermined region.

The bag-shaped container 100 according to the present exemplary embodiment is manufacturable by the above-described process. It is to be noted that the above-described process is merely an example, and various modifications are possible. For instance, the tab forming unit 620 and the cut forming unit 630 may be disposed in reverse order from the above-described example. Alternatively, the tab forming unit 620 and the cut forming unit 630 may be integrated to form the cut 151 and the cut 121 substantially simultaneously. In another example, the seal bars 651A and 651B that are included in the top/bottom seal forming unit 650 may be separated from the cutter 652 and receiver base 653 that are also included in the top/bottom seal forming unit 650, thereby cutting the film 110 in the width direction after the top seal portion 102 and the bottom seal portion 103 are formed.

In another example, the sealers 654A and 654B may form the surrounding seal portion 160 before the seal bars 651A and 651B form the top seal portion 102 and the bottom seal portion 103. For instance, the sealers 654A and 654B are disposed above the seal bars 651A and 651B, and the surrounding seal portion 160 is formed before the bottom seal portion 103 located at a bottom of the bag-shaped container 100 is formed. This makes it possible to prevent the contents to be filled in synchronization with the forming of the bottom seal portion 103 from adhering to a region on an inner side of the surrounding seal portion 160. It is to be noted that the bag-shaped container 100 is not necessarily manufactured while being filled with the contents. For instance, the above-described manufacturing device 600 may omit the filling device 601, and may thereby manufacture the bag-shaped container 100 that is not filled with the contents.

In another example, the tab forming unit 620 may be disposed in a subsequent stage of the sealers 654A and 654B that form the surrounding seal portion 160. In this case, in the tab forming unit 620, the cutter 621 is disposed on the side of the first film 111 and the receiver base 622 is disposed on the side of the second film 112. The cut 151 that defines the tab does not completely pass through the second film 112. A cut depth of the cutter 621 is thus adjusted to a value corresponding to a total thickness of the first film 111, the tearing strip 120, and the belt-shaped base 130. Forming the cut 151 after the surrounding seal portion 160 makes it possible to minimize deformation of the cut due to thermal shrinkage of the film caused by heat sealing or ultrasonic sealing, for instance.

It is to be noted that bag-shaped containers according to other exemplary embodiments to be described below are manufacturable by combining the process of manufacturing the bag-shaped container 100 according to the first exemplary embodiment as described above with a process of manufacturing another known bag-shaped container, or by replacing a portion of the process of manufacturing the bag-shaped container 100 with a process of manufacturing another bag-shaped container. Accordingly, in the following description of other exemplary embodiments, description of manufacturing processes will be omitted.

### Second Exemplary Embodiment

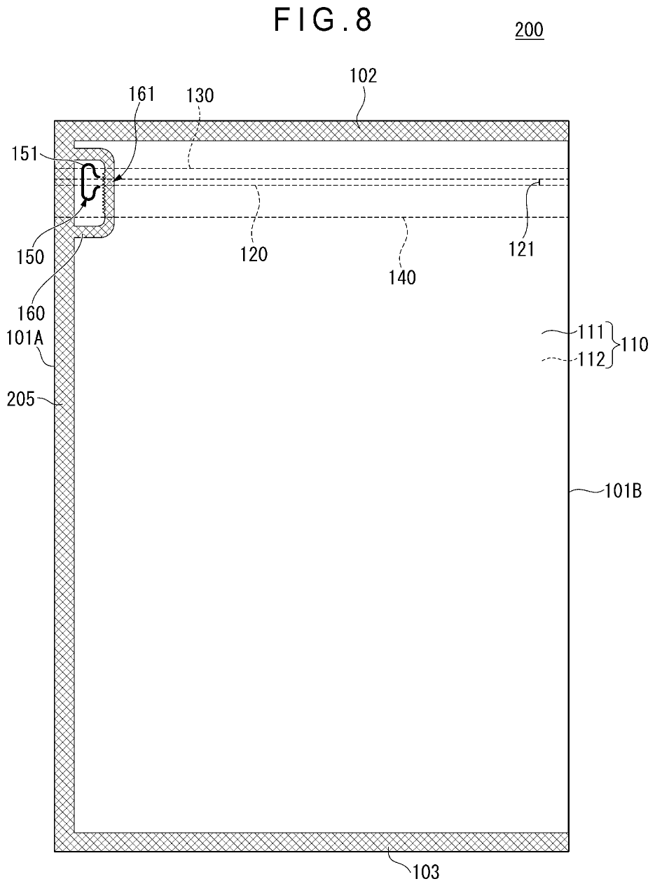

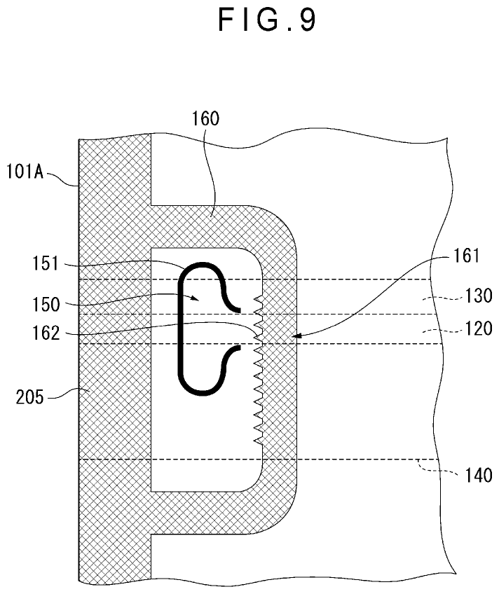

FIG. 8 is a plan view of a bag-shaped container according to a second exemplary embodiment of the invention. FIG. 9 is an enlarged view of a surrounding seal portion of the bag-shaped container illustrated in FIG. 8. In the present exemplary embodiment, the back seal portion is not provided in a bag-shaped container 200, and instead, a side seal portion 205 is provided in the side portion 101A. When such a side seal portion 205 is provided, the surrounding seal portion 160 together with the side seal portion 205 form a bonding region that encloses four sides of the tab 150. Accordingly, in the present exemplary embodiment, the seal bar that forms the surrounding seal portion 160 includes a substantially rectangular planar shape enclosing four sides of a predetermined region in which the tab is defined by the cut 151, and the inner edge on at least one side of the planar shape includes at least one protrusion. In the illustrated example, the seal bar is integrally formed with a seal bar that forms the side seal portion 205. It is to be noted that configurations of the present exemplary embodiment other than those described above are similar to those of the above-described first exemplary embodiment, and thus redundant description thereof is omitted. The modifications described for the first exemplary embodiment is similarly applicable in the present exemplary embodiment.

### Third Exemplary Embodiment

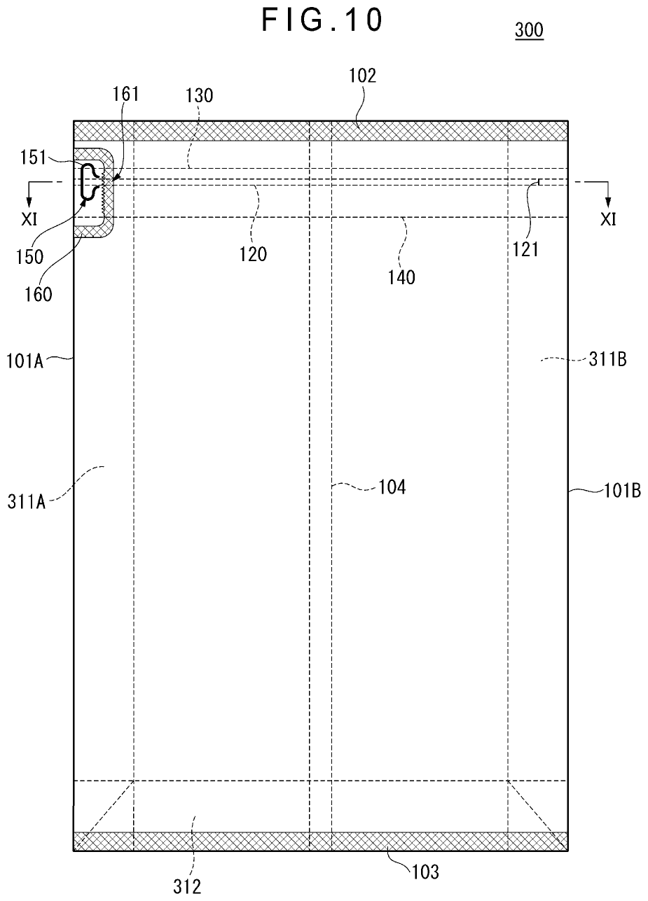

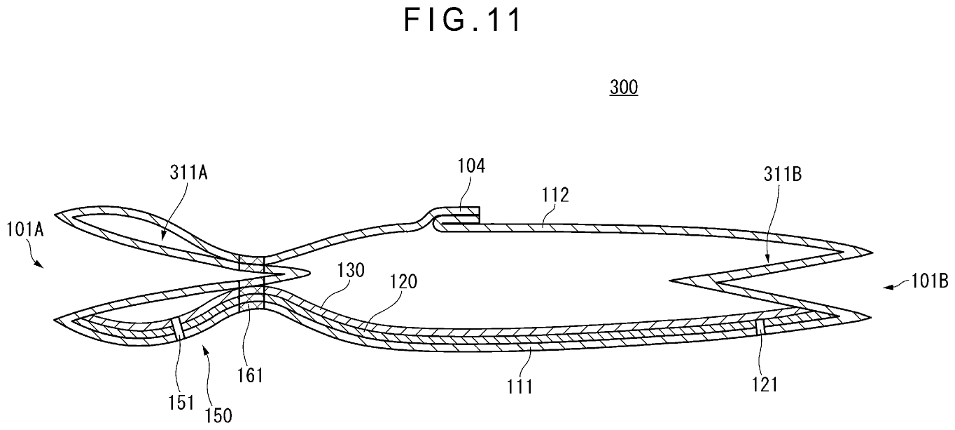

FIG. 10 is a plan view of a bag-shaped container according to a third exemplary embodiment of the invention. FIG. 11 is a cross-sectional view taken along a line XI-XI of the bag-shaped container illustrated in FIG. 10. In the present exemplary embodiment, a bag-shaped container 300 is what is called a gusset bag, and portions 311A and 311B are respectively provided in the side portions 101A and 101B of the bag-shaped container 300. In each of the portions 311A and 311B, the film 110 is folded into the inside of the container body. Accordingly, as illustrated in FIG. 11, the surrounding seal portion 160 according to the present exemplary embodiment bonds the first film 111, the tearing strip 120, the belt-shaped base 130, and a film included in the portion 311A folded inside with each other. That is, in the surrounding seal portion 160 according to the present exemplary embodiment, the film included in the portion 311A folded inside corresponds to the second film 112 according to the first exemplary embodiment. A portion 312 is provided at a bottom of the bag-shaped container 300. In the portion 312, a film different from the film 110 is folded into the inside of the container body.

It is to be noted that a configuration of the gusset bag is not limited to the above-described example, and various known techniques are available. For instance, the part of the side portion folded inside may include a film different from the film 110. Further, as with the second exemplary embodiment described above for instance, the side seal portion may be provided instead of the back seal. Configurations of the present exemplary embodiment other than those described above are similar to those of the above-described first exemplary embodiment, and thus redundant description thereof is omitted. The modifications described for the first exemplary embodiment is similarly applicable in the present exemplary embodiment.

### Fourth Exemplary Embodiment

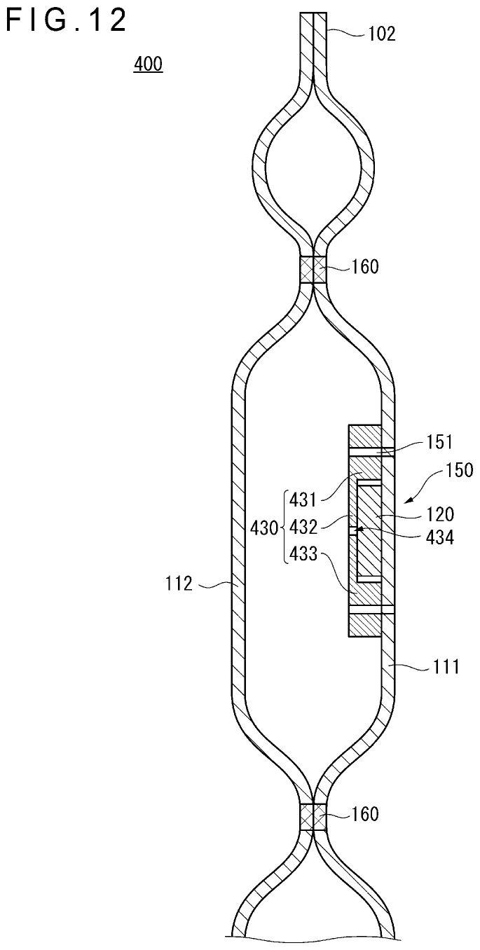

FIG. 12 is a cross-sectional view of a bag-shaped container according to a fourth exemplary embodiment of the invention. FIG. 12 is the cross-sectional view of a part taken along a line III-III indicated in FIG. 1. In the present exemplary embodiment, a bag-shaped container 400 includes no zipper portion. In the illustrated example, a cross section of a belt-shaped base 430 includes a concave portion 432, and convex portions 431 and 433 on both sides of the concave portion 432. The tearing strip 120 is disposed on the concave portion 432. The concave portion 432 has a slit 434. The tearing strip 120 undergoes the interfacial peeling from the belt-shaped base 430 and tears the first film 111 to form the opening portion in the container body. Thereafter, the inside of the container body is accessible via the slit 434. In the present exemplary embodiment also, the first film 111, the tearing strip 120, the concave portion 432 of the belt-shaped base 430, and the second film 112 are bonded to each other in the surrounding seal portion 160. The present exemplary embodiment is thus similar to the first exemplary embodiment in that it is possible to smoothly separate the tearing strip 120 and the belt-shaped base 430 from each other, by causing the edge on the side of the tab 150 at the intersection of the surrounding seal portion 160 with the tearing strip 120 to have a shape that is at least partially not orthogonal to the longitudinal direction of the tearing strip 120. Configurations of the present exemplary embodiment other than those described above are similar to those of the above-described first exemplary embodiment, and thus redundant description thereof is omitted. The modifications described for the first exemplary embodiment is similarly applicable in the present exemplary embodiment.

It is to be noted that an embodiment in which no zipper portion is provided as with the fourth exemplary embodiment is employed when re-sealing and re-unsealing of the bag-shaped container are unnecessary after the opening is formed. The configuration in such a case is not limited to the example of the fourth exemplary embodiment, and may be, for instance, a configuration in which the zipper portion 140 is excluded from the configuration of the first exemplary embodiment as illustrated in the cross-sectional view of FIG. 3, for instance.

### Fifth Exemplary Embodiment

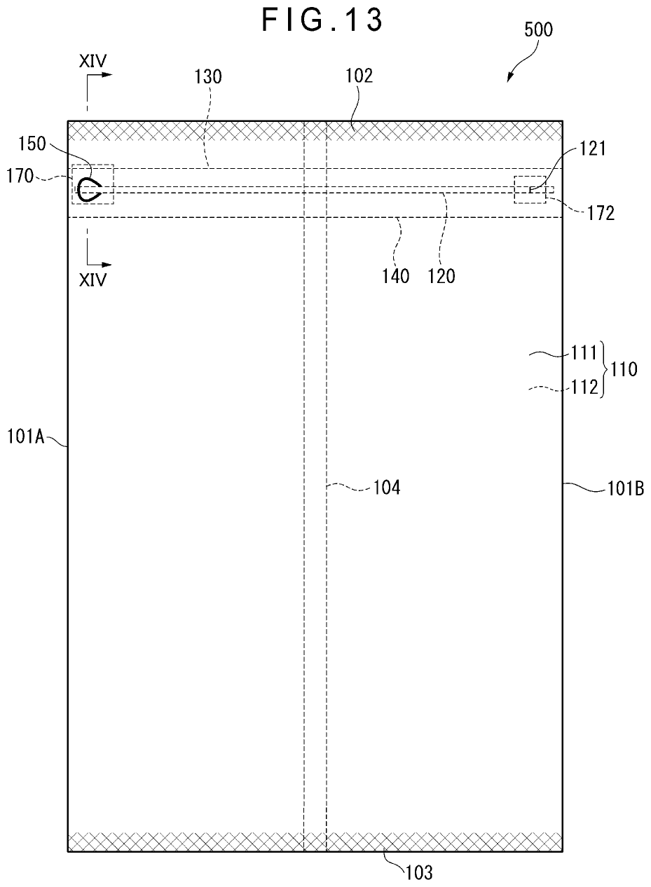

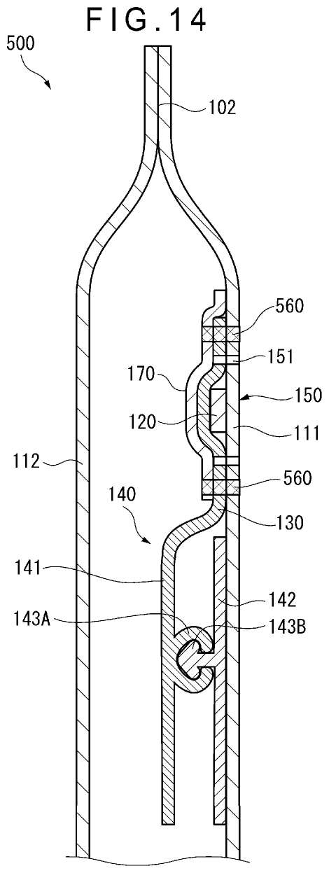

FIG. 13 is a plan view of a bag-shaped container according to a fifth exemplary embodiment of the invention. FIG. 14 is a cross-sectional view taken along a line XIV-XIV of the bag-shaped container illustrated in FIG. 13. In the illustrated example, a bag-shaped container 500 includes the film 110, the tearing strip 120, the belt-shaped base 130, the zipper portion 140, and a protector 170. The tab 150 is provided at a position close to one of the side portions, i.e., the side portion 101A, of the bag-shaped container 100. In other words, the tab 150 is provided near one end portion in the longitudinal direction of the elongated member including the tearing strip 120, the belt-shaped base 130, and the zipper portion 140. The protector 170 bonded to a region covering the tab 150 is also included in the elongated member.

The protector 170 is bonded, on a side of the belt-shaped base 130, to the region covering the tab 150 defined by the cut 151. The cut 151 passes through the first film 111, the tearing strip 120, and the belt-shaped base 130. As illustrated in the example, the protector 170 may at least partially extend beyond the belt-shaped base 130 and may also be bonded to the first film 111. The protector 170 seals a space leading to the cut of the tab 150 on an inner side of the container body, making it possible to improve sealability of the bag-shaped container 500 before being unsealed with use of the tearing strip 120. The material of the protector 170 is, for instance, similar to that of the film 110 described above. Among the above-described materials, different materials may be selected for the protector 170 and the film 110, but it is more preferable to select the same material for the protector 170 and the film 110.

Further, the bag-shaped container 500 may have a protector 172 disposed in such a manner as to cover, on the inner side of the container body, a region in which the cut 121 is provided on the opposite side to the tab 150. This makes it possible to improve the sealability of the bag-shaped container 500 before being unsealed with use of the tearing strip 120. Alternatively, the cut 121 may be provided in such a manner as to pass through the first film 111 and the tearing strip 120 but does not pass through the belt-shaped base 130. In this case, the space leading to the cut 121 does not reach the inner side of the container body. The protector 172 may thus not be disposed. Further, as described in the first exemplary embodiment, the cut 121 may not necessarily be provided.

As illustrated in FIG. 14, the protector 170 is bonded to the belt-shaped base 130 in a surrounding seal portion 560. The surrounding seal portion 560 is a bonding region that surrounds the tab 150 and includes an intersection that traverses the tearing strip 120 and the belt-shaped base 130, as with the surrounding seal portion described above in the first exemplary embodiment. The first film 111, the tearing strip 120, the belt-shaped base 130, and the protector 170 are bonded to each other in the surrounding seal portion 560 by, for instance, heat sealing or ultrasonic sealing. The tab 150 is provided in a non-bonded region adjacent to the surrounding seal portion 560, that is, in a region where the belt-shaped base 130 and the protector 170 are not bonded to each other. Surrounding the tab 150 with the surrounding seal portion 560 spatially separates a space that communicates with an outside via the cut 151 of the tab 150 from another space inside the container body across the surrounding seal portion 560 and the protector 170 serving as the bonding region. This therefore makes it possible to maintain sealing performance of the container body even when the tab 150 is defined by the cut 151 that passes through the first film 111.

In an intersection where the surrounding seal portion 560 traverses the tearing strip 120 and the belt-shaped base 130, an edge, of the surrounding seal portion 560, on a side of the tab 150 has a shape that is at least partially not orthogonal to the longitudinal direction of the tearing strip 120. Specifically, the intersection of the surrounding seal portion 560 is configured similarly to that in the example described with reference to FIG. 5 for the first exemplary embodiment, for instance. This makes it possible to smoothly separate the tearing strip 120 and the belt-shaped base 130 from each other when forming the opening portion in the container body with use of the tearing strip 120. It is to be noted that configurations of the present exemplary embodiment other than those described above are similar to those of the above-described first exemplary embodiment, and thus redundant description thereof is omitted. The modifications described for the first exemplary embodiment is similarly applicable in the present exemplary embodiment. Further, it is possible to combine the second, third, and fourth exemplary embodiments with the present exemplary embodiment.

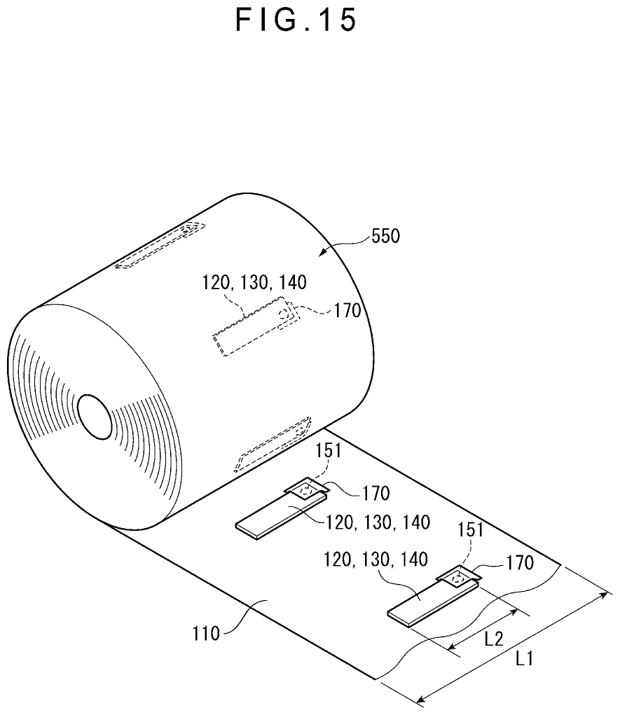

FIG. 15 illustrates an exemplary configuration of a film assembly according to the fifth exemplary embodiment of the invention. A film assembly 550 according to the present exemplary embodiment includes the film 110 before being folded back on the side portions 101A and 101B, and at least two elongated members that are attached to one surface of the film 110 and are separated from each other along a longitudinal direction of the film 110 wound in a roll. The elongated member includes the tearing strip 120, the belt-shaped base 130, the zipper portion 140, and the protector 170. In the elongated member, the tab is defined by the cut 151. Further, the surrounding seal portion 560 (see FIG. 14) that is the bonding region in which the film 110, the tearing strip 120, the belt-shaped base 130, and the protector 170 are bonded to each other, is also provided. A width L1 of the film is greater than twice a length L2 of the elongated member in order to form the container body by being folded back as described above.

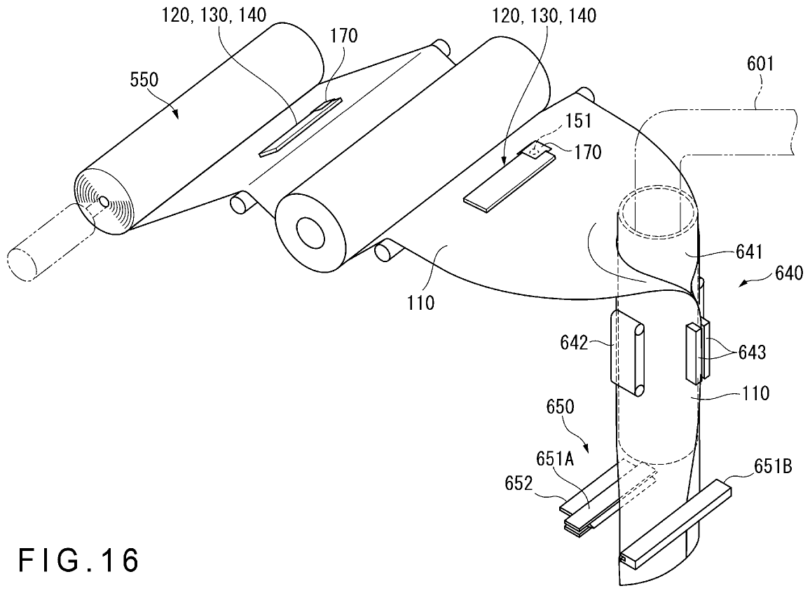

FIG. 16 illustrates a process of manufacturing a bag-shaped container using the film assembly illustrated in FIG. 15. As described above, the film assembly 550 unrolled from the roll has the elongated member including the tearing strip 120, the belt-shaped base 130, the zipper portion 140, and the protector 170 attached thereto. Thus, no process is necessary to attach those members to the film assembly 550 during the manufacture of the bag-shaped container. The film assembly 550 is formed into a bag-shaped container by the back-seal forming unit 640 and the top/bottom-seal forming unit 650 in a manner similar to the example illustrated in FIG. 6. In the present exemplary embodiment, the surrounding seal portion 560 is already provided on the film assembly 550 as described above. Thus, the top/bottom-seal forming unit 650 may not include the sealer for forming the surrounding seal portion.

It is to be noted that the process of manufacturing the bag-shaped container according to the present exemplary embodiment is not limited to such an example. For instance, as with the example illustrated in FIG. 6, the process of attaching the elongated member to the film 110 upon manufacturing the bag-shaped container may be performed. In this case, after the tab is defined by the cut 151 on the elongated member, a process of bonding the protector 170 to the elongated member in the surrounding seal portion 560 is performed.

### Examples

Examples of the invention will be described below. In Example 1, the protrusion was provided at the edge on the side of the tab at the intersection of the surrounding seal portion with the tearing strip as described above as the exemplary embodiments. In Comparative Example 1, the edge, of the intersection, on the side of the tab had a straight line and no protrusion was provided. A maximum value of a tensile strength during a period from when the tab was grasped and the pulling of the tab was started until the tearing of the film with use of the tearing strip passed the intersection of the surrounding seal portion (i.e., a maximum value of a tensile strength upon unsealing) was measured for Example 1 and Comparative Example 1. It is to be noted that the tensile strength was measured at a tensile rate of 300 mm/min using a “digital force gauge” available from Imada Corporation. In each of Example 1 and Comparative Example 1, the tearing strip included the polypropylene random copolymer and the belt-shaped base included low-density polyethylene. The results of Example and Comparative Example shown in Table 1 revealed that providing the protrusion on the edge of the bonding region greatly reduced the maximum value of the tensile strength upon unsealing.

TABLE 1
Table 1: Results of Example and Comparative Example

| | Example 1 | Comparative Example 1 |
|---|---|---|
| Maximum value of tensile | 11.6 | 17.0 |
| strength (N) upon unsealing | | |

Preferred exemplary embodiments of the invention have been described above in detail with reference to the accompanying drawings, but the invention is not limited to such exemplary embodiments. It is apparent that a skilled person in the art of the invention can arrive at various alterations and modifications within the scope of the technical idea recited in the appended claims, and it is understood that such alterations and modifications naturally fall within the technical scope of the invention.

1. A container comprising:
a first film that configures a container body;
a tearing strip;
a belt-shaped base; and
a second film that configures the container body, wherein
the container comprises a part in which the first film, the tearing strip, the belt-shaped base, and the second film are stacked in this order,
a bonding region in which the first film, the tearing strip, the belt-shaped base, and the second film are bonded to each other is formed traversing the tearing strip and the belt-shaped base,
a tab is defined by a cut in a non-bonded region, the cut passing through at least the first film and the tearing strip, the non-bonded region being adjacent to the bonding region, and
an edge, of the bonding region, on a side of the tab is at least partially not orthogonal to a longitudinal direction of the tearing strip.

2. The container according to claim 1, wherein the edge, of the bonding region, on the side of the tab comprises at least one protrusion.

3. The container according to claim 2, wherein the protrusion has a chevron shape, a trapezoidal shape, a rectangular shape, or an arc shape.

4. The container according to claim 2, wherein the protrusion has a width of greater than or equal to 0.3 mm.

5. The container according to claim 4, wherein the protrusion has a width of less than or equal to 3 mm.

6. The container according to claim 2, wherein the protrusion has a protrusion height of greater than or equal to 0.3 mm.

7. The container according to claim 6, wherein the protrusion has a protrusion height of less than or equal to 5 mm.

8. The container according to claim 2, wherein the protrusion comprises a plurality of protrusions, and
the edge, of the bonding region, on the side of the tab is provided with the plurality of the protrusions that overlap with the tearing strip.

9. The container according to claim 8, wherein a width of a range over which the plurality of protrusions are provided is greater than or equal to a width of the tearing strip.

10. The container according to claim 1, further comprising:
a first base provided continuously with the belt-shaped base;
a second base opposed to the first base and bonded to the first film; and
a first engagement portion and a second engagement portion that respectively protrude from the first base and the second base and are engageable with each other.

11. The container according to claim 1, wherein the first film and the second film are provided by folding back a single film.

12. The container according to claim 1, wherein the bonding region at least partially surrounds the tab.

13. The container according to claim 1, wherein the container body has a bag shape.

14. A container manufacturing method comprising:
forming a bonding region by stacking a first film that configures a container body, a tearing strip, a belt-shaped base, and a second film that configures the container body in this order and bonding the first film, the tearing strip, the belt-shaped base, and the second film to each other, the bonding region formed traversing the tearing strip and the belt-shaped base; and
forming a tab defined by a cut in a non-bonded region, the cut passing through at least the first film and the tearing strip, the non-bonded region being adjacent to the bonding region, wherein
an edge, of the bonding region, on a side of the tab is at least partially not orthogonal to a longitudinal direction of the tearing strip.

15. A container manufacturing device comprising:
a unit configured to form a bonding region by stacking a first film that configures a container body, a tearing strip, a belt-shaped base, and a second film that configures the container body in this order and bonding the first film, the tearing strip, the belt-shaped base, and the second film to each other, the bonding region formed traversing the tearing strip and the belt-shaped base; and
a unit configured to form a tab defined by a cut in a non-bonded region, the cut passing through at least the first film and the tearing strip, the non-bonded region being adjacent to the bonding region, wherein
an edge, of the bonding region, on a side of the tab is at least partially not orthogonal to a longitudinal direction of the tearing strip.

16. A seal bar comprising:
a planar shape surrounding at least three sides of a predetermined region; and
at least one protrusion on an inner edge of at least one side of the planar shape.

17. A container comprising:
a first film that configures a container body;
a tearing strip;
a belt-shaped base; and
a second film that configures the container body, wherein
the container comprises a part in which the first film, the tearing strip, the belt-shaped base, and the second film are stacked in this order,
the container further comprises a protector that is bonded, on a side of the belt-shaped base, to a region covering a tab defined by a cut passing through the first film, the tearing strip, and the belt-shaped base,
a bonding region in which the first film, the tearing strip, the belt-shaped base, and the protector are bonded to each other is formed traversing the tearing strip and the belt-shaped base,
the tab is provided in a non-bonded region adjacent to the bonding region, and
an edge, of the bonding region, on a side of the tab is at least partially not orthogonal to a longitudinal direction of the tearing strip.

18. The container according to claim 17, wherein
the container body has a bag shape,
the edge, of the bonding region, on the side of the tab comprises at least one protrusion,
the protrusion has a width in a range from 0.3 mm to 3 mm, and
the protrusion has a protrusion height in a range from 0.3 mm to 5 mm.

19. The container according to claim 17, further comprising:
a first base provided continuously with the belt-shaped base;
a second base opposed to the first base and bonded to the first film; and
a first engagement portion and a second engagement portion that respectively protrude from the first base and the second base and are engageable with each other.

20. A film assembly comprising:
a film; and
at least two elongated members that are attached to one surface of the film and are separated from each other along one direction of the film, wherein
the elongated members each comprise a tearing strip, a belt-shaped base, and a protector, the belt-shaped base being stacked on the tearing strip, the protector being bonded, on a side of the belt-shaped base, to a region covering a tab defined by a cut passing through the film, the tearing strip, and the belt-shaped base,
a bonding region in which the film, the tearing strip, the belt-shaped base, and the protector are bonded to each other is formed traversing the tearing strip and the belt-shaped base,
the tab is provided in a non-bonded region adjacent to the bonding region, and
an edge, of the bonding region, on a side of the tab is at least partially not orthogonal to a longitudinal direction of the tearing strip.

21. The film assembly according to claim 20, wherein
the edge, of the bonding region, on the side of the tab comprises at least one protrusion,
the protrusion has a width in a range from 0.3 mm to 3 mm, and
the protrusion has a protrusion height in a range from 0.3 mm to 5 mm.

22. The film assembly according to claim 20, further comprising:
a first base provided continuously with the belt-shaped base;
a second base opposed to the first base and bonded to the film; and
a first engagement portion and a second engagement portion that respectively protrude from the first base and the second base and are engageable with each other.
